(19) United States
(12) Patent Application Publication
(10) Pub. No.: US 2006/0130146 A1
(43) Pub. Date: Jun. 15, 2006

(54) Network packet generation apparatus and method having attack test packet generation function for information security system test

(76) Inventors: Yang Seo Choi, Taejon (KR); Dong Il Seo, Taejon (KR)

Correspondence Address: DLA PIPER RUDNICK GRAY CARY US LLP, P. O. BOX 9271, RESTON, VA, 20195, US

(21) Appl. No.: 11/023,660

(22) Filed: Dec. 29, 2004

(30) Foreign Application Priority Data
Nov. 24, 2004 (KR) 2004-97110

(51) Int. Cl. G06F 11/00

(52) U.S. Cl. 726/25

(57) ABSTRACT

A network packet generation apparatus and method with an attack test packet generation function for testing a performance of an information security system is provided. The network packet generation method includes the steps of: setting attack test packets according to setting data inputted by a user and a pre-stored attack detection rule; generating the attack test packets according to the setting data; transmitting the attack test packets to the information security system and receiving monitored and stored reaction packets against the attack test packets; and analyzing the received reaction packets, thereby making it possible to improve the accuracy and reliability of an information security system test and reduce the necessary time for the information security system test.

### BACKGROUND OF THE INVENTION

1. Field of the Invention

The present invention relates to a network packet generation apparatus and method for an information security system test, and more particularly, to a network packet generation apparatus and method having an attack test packet generation function for an information security system test, which generates attack test packets substantially identical to actual attack packets and tests an information security system by using the generated attack test packets to thereby cope with various actual attacks such as hacking and intrusion.

2. Description of the Related Art

Various attacks such as hacking and intrusion are diversified with development of the Internet, and countermeasures for coping with such attacks are being researched and developed.

The conventional information security system test methods generate attack test packets by using the existing network test equipment or directly try hacking by using an actual attack program to thereby test a function of an information security system.

Of the two, the conventional information security system test method using the existing network test equipment has a limitation in that its attack test packets generated for an information security function test are different in many respects from actual attack packets. This is because the method simply generates a plurality of the same attack test packets and repeatedly transmits the same attack test packets without passing through the 3-way handshaking process, contrary to an actual attack. Accordingly, the method cannot exactly cope with actual attack environments.

In the meantime, the conventional information security system test method using the actual attack program has a drawback in that it requires too much time for an information security function test. This is because the method requires too much time so as to directly try various attacks with the actual attack program.

### SUMMARY OF THE INVENTION

Accordingly, the present invention is directed to a network packet generation apparatus and method having an attack packet generation function for an information security system test. The apparatus generates attack test packets substantially identical to actual attack packets, transmits the attack test packet to an information security system and ascertains how the information security system actually copes with the attack test packets to thereby improve the accuracy and reliability of an information security system test and reduce the necessary time for the test. Also, the apparatus provides: a technique for classifying various attacks (such as a common hacking attack, a service rejection attack, an Internet worm attack and a scan attack) and easily selecting corresponding attack test packets; an evasion technique including a packet division function, for testing a performance of the network information security system; a technique for ascertaining whether the information security system successfully intercepts the attack test packets or not by monitoring packets transmitted and received in the network so as to ascertain the result of the reaction of the information security system against the attack test packets; and a technique for providing a client-server environment capable of emulating a corresponding connection for an attack using the connection-based protocol so as to make a test attack substantially identical to an actual attack.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a network packet generation apparatus with an attack test packet generation function for testing a performance of an information security system. The apparatus includes: a system controller for setting attack test packets according to received setting data about the attack test packets and a pre-stored attack detection rule and combining the attack test packets with monitored reaction packets thereagainst; a packet generator for generating the attack test packets according to the setting data; a packet monitor for monitoring the attack test packets and the reaction packets received from the information security system; a connection managing unit for connecting and managing a network; and network interface cards connected respectively to the packet generator and the packet monitor.

In another aspect of the present invention, there is provided a network packet generation method with an attack test packet generation function for testing a performance of an information security system. The method includes the steps of: setting attack test packets according to setting data inputted by a user and a pre-stored attack detection rule; generating the attack test packets according to the setting data; transmitting the attack test packets to the information security system and receiving monitored and stored reaction packets against the attack test packets; and analyzing the received reaction packets.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram of a network packet generation apparatus having an attack packet generation function for an information security system test according to an embodiment of the present invention;

FIG. 2 is a block diagram of a system controller shown in FIG. 1;

FIG. 3 is a block diagram of a packet generator shown in FIG. 1;

FIG. 4 is a block diagram of a packet monitor shown in FIG. 1;

FIG. 5 is a diagram illustrating an example of testing a function of an information security system by using the network packet generation apparatus shown in FIG. 1; and

FIG. 6 is a flow diagram illustrating a network packet generation method with an attack packet generation function for an information security system test according to an embodiment of the present invention.

### DETAILED DESCRIPTION OF THE INVENTION

Reference will now be made in detail to the preferred embodiments of the present invention, examples of which are illustrated in the accompanying drawings.

Since information security systems have been recently developed so that they can serve as a gateway of a wide area network (WAN) and simultaneously perform an information security function, their accuracy and reliability become very influential. Accordingly, the present invention provides an attack test packet generation function for testing a function of the information security system, to thereby improve the accuracy and reliability of an information security system test and reduce time required for the test when compared to the conventional information security system test method using the existing network test equipment. In the meantime, in order to guarantee the accuracy and reliability of the information security system, it is necessary to generate attack test packets substantially identical to various possible attack packets and to perform the information security system test by using the attack test packets.

The most important barometer for estimating a performance of the information security system is broadly classified into the accuracy of an intrusion detection and the suitableness of an reaction to an detected intrusion. The accurate intrusion detection means that there is no failure in detection of attack packets and no mistaken detection of non-attack packets as attack packets. The suitable reaction to the detected intrusion means that the reaction is performed suitably to the detected intrusion according to well-classified intrusion types.

When reviewing such two barometers, the accuracy of the intrusion detection is related to the generation of the attack test packets, and the suitableness of the reaction to the detected intrusion is related to the ascertainment of whether or not an expected reaction to a specific attack packet is actually performed. Accordingly, the information security system test equipment should have a function for generating attack test packets substantially identical to actual attack packets and a function for ascertaining how reactions to the actual attack packets are actually performed.

Therefore, how to generate attack test packets is very important for an accurate test of an information security system function.

Accordingly, the present invention is designed to provide a technique for classifying attacks into the following attacks and easily selecting corresponding attack test packets.

Common Hacking Attack: to unlawfully access a specific system and then obtain non-permitted authority and information or use the system's resource without permission

Service Rejection Attack: to paralyze a targeted network or system by various methods and thereby prevent or block the use of the network or system by lawful users

Internet Worm Attack: to automatically infect many systems in a network all at once and thereby paralyze the system by generating a large quantity of network packets

Scan Attack: to simultaneously transmit packets to many ports of a specific system or to a specific port of many system so as to ascertain the existence or nonexistence of the systems' specific defects

Also, the present invention is designed to provide an evasion technique for testing a performance of a network information security system. The evasion technique includes various attack detection evasion techniques such as a packet division technique, which are generally used by hackers for preventing their intrusion attacks from being detected.

Furthermore, the present invention is designed to provide a technique for ascertaining whether the information security system successfully intercepts the attack test packets or not by monitoring packets exchanged between the apparatus and the information security system so as to ascertain the result of the reaction of the information security system against the attack test packets.

Lastly, the present invention is designed to provide a technique for providing a client-server environment capable of emulating a corresponding connection for an attack using the connection-based protocol so as to make a test attack substantially identical to an actual attack.

The provision of such techniques makes it possible to generate network attack test packets substantially identical to actual network attack packets, and the execution of the information security system test by the network attack test packets makes it possible to guarantee the reliability and stability of the information security system.

A network packet generation apparatus with an attack test packet generation function for an information security system test will now be described in detail with reference to the accompanying drawings.

FIG. 1 is a block diagram of a network packet generation apparatus having an attack packet generation function for an information security system test according to an embodiment of the present invention.

Referring to FIG. 1, the network packet generation apparatus with an attack test packet generation function for testing a performance of an information security system is constructed to include a system controller 200, a packet generator 300, a packet monitor 400, a connection managing unit 500 and network interface cards (NICs) 600 and 700. The system controller 200 sets attack test packets and constitutes various environments. The packet generator 300 actually generates the set attack test packets. The packet monitor 400 monitors the generated attack test packets. The connection managing unit 500 actually connects a network and manages the connection. The NICs 600 and 700 are connected respectively to the packet generator 300 and the packet monitor 400, and may have various shapes and bandwidths.

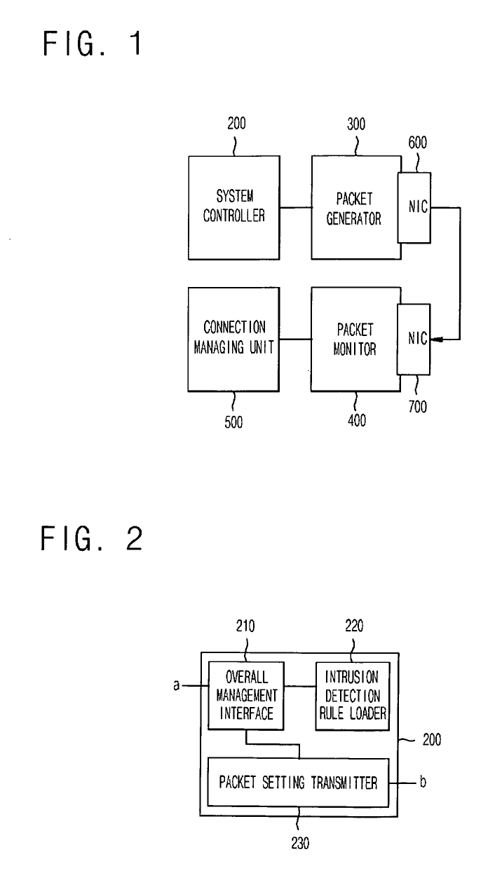

FIG. 2 is a block diagram of a system controller shown in FIG. 1.

Referring to FIG. 2, the system controller 200 is constructed to include an overall management interface 210, an intrusion detection rule (or code) loader 220 and a packet setting transmitter 230. The overall management interface 210 controls an over operation of the network packet generation apparatus. The intrusion detection rule loader 220 stores intrusion detection rule therein. The packet setting transmitter 230 transmits attack test packets' settings to a corresponding device requiring the settings.

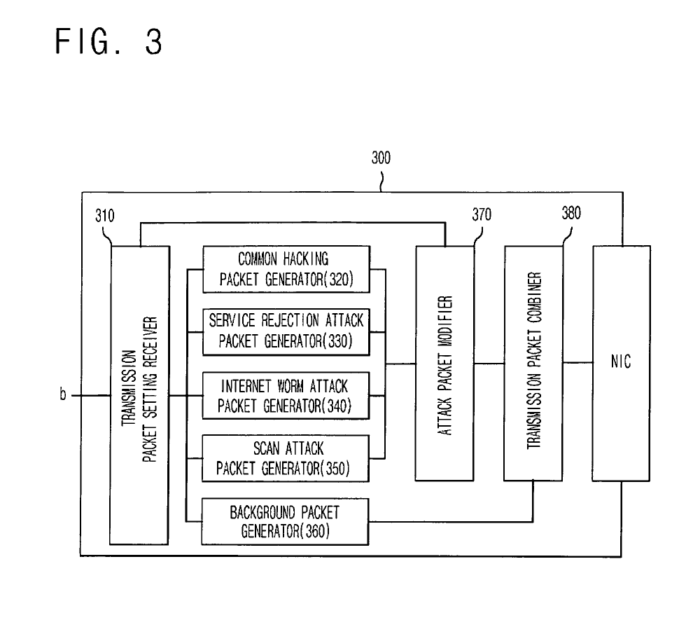

FIG. 3 is a block diagram of a packet generator shown in FIG. 1.

Referring to FIG. 3, the packet generator 300 is constructed to include a transmission packet setting receiver 310, a common hacking packet generator 320, a service rejection attack packet generator 330, an Internet worm attack packet generator 340, a scan attack packet generator 350, a background packet generator 360, an attack packet modifier 370 and a transmission packet combiner 380. The transmission packet setting receiver 310 receives the attack test packets' settings. The common hacking packet generator 320, the service rejection attack packet generator 330, the Internet worm attack packet generator 340, the scan attack packet generator 350 and the background packet generator 360 constitute a packet generator group. Here, the packet generators 320, 330, 340 and 350 generate respective hacking packets according to respective packets' settings, and the background packet generator 360 generates background traffics. The attack packet modifier 370 modifies packets generated by the respective attack packet generators so as to make it impossible to detect an intrusion, if necessary. The transmission packet combiner 380 combines overall packets prior to transmission. Here, the NIC 600 is connected to the transmission packet combiner 380.

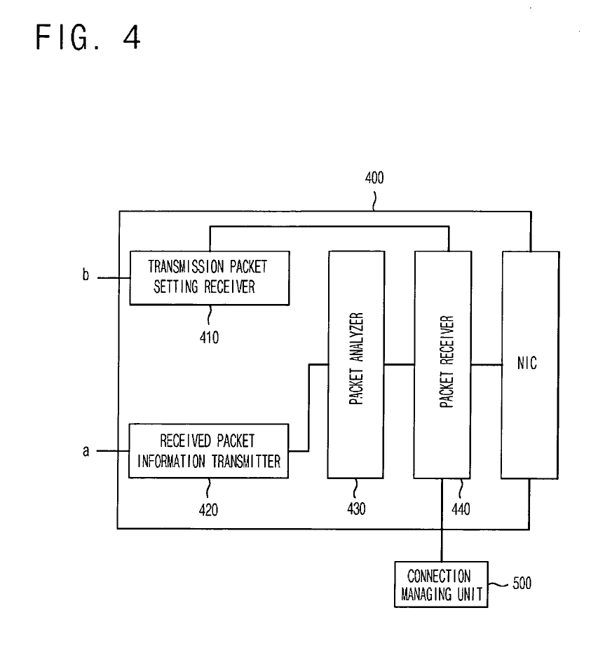

FIG. 4 is a block diagram of a packet monitor shown in FIG. 1.

Referring to FIG. 4, the packet monitor 400 is constructed to include a transmission packet setting receiver 410, a received packet information transmitter 420, a packet analyzer 430 and a packet receiver 440. The transmission packet setting receiver 410 receives a transmission packets' settings. The received packet information transmitter 420 transmits received packet information. The packet analyzer 430 analyzes received packets. The packet receiver 440 actually receives packets and transmits the received packets to the connection managing unit 500, if necessary. Here, the NIC 700 is connected to the packet receiver 400.

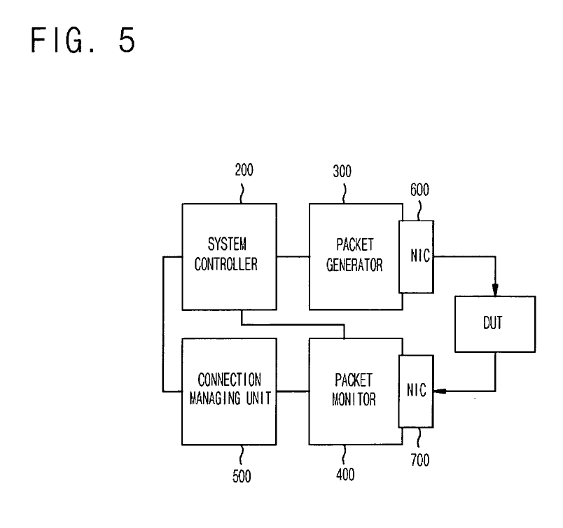

FIG. 5 is a diagram illustrating an example of testing a function of an information security system by using the network packet generation apparatus shown in FIG. 1.

As shown in FIG. 5, the network packet generation apparatus according to the present invention performs an information security function test on a device under test (DUT).

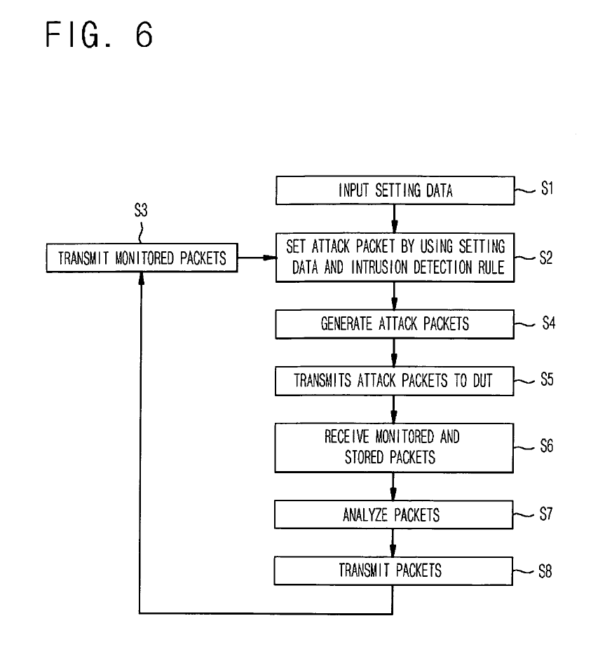

A network packet generation method having an attack test packet generation function for an information security system test will now be described in detail with reference to FIG. 6.

FIG. 6 is a flow diagram illustrating a network packet generation method with an attack packet generation function for an information security system test according to an embodiment of the present invention.

Referring to FIG. 6, in the network packet generation method, attack test packets are generated according to setting data inputted by a user and a pre-stored attack detection rule (S1 and S2). Here, monitored packets may be combined with the attack test packets' settings (S3). The attack test packets are generated according to the setting data (S4). The attack test packets are transmitted to the information security system (i.e., DUT), and monitored and stored reaction packets against the attack test packets are received (S5 and S6). The received reaction packets are analyzed and transmitted to the system controller 200 (S7 and S8). This will be described in detail later.

In the meantime, the network packet generation method for an information security system test includes: (a) a function for generating attack test packets similar to common hacking packets; (b) a function for generating attack test packets similar to Internet worm packets; (c) a function for generating attack test packets similar to distributed service rejection attack packets; (d) a function for retransmitting packets monitored and stored in a network; (e) a function for randomly manipulating header and dater regions of all the transmitted packets; and (f) a function for applying an intrusion evasion technique to attack test packets.

The functions (a) through (f) will now be described in detail.

The function (a) makes a situation similar to the common hacking situation to thereby test whether or not an information security system detects and reacts to the so-generated attack. The function (a) is performed by the following steps.

The first step for determining a format of an attack test packet according to an intrusion detection rule contained in the existing information security system

The second step for selecting an attack type to be used for the information security system test

The third step for setting a connection according to a corresponding protocol and network port number if the selected attack is an attack performed through the connection-based protocol

The last step for performing an attack by using the set connection

In the first step, the attack packet format is determined by reading the intrusion detection rule contained in the existing information security system, which is performed prior to actual generation of the attack test packet. In the second step, the attack to be applied to the information security system test is selected. In the third step, the connection is set prior to transmission of the attack test packet. The last step is a step of actually transmitting the attack test packet.

In the third step, the connection may not be set even though the selected attack is an attack performed through the connection-based protocol. This is for effectively testing an information security system supporting a stateful inspection function. That is, in case of the information security system providing the stateful inspection, even though an attack packet is detected and if an connection is not actually set, the detected attack packet should not be considered as an attack.

The function (b) is an attack test packet generation function for detecting and reacting to the Internet worm attack recently most troublesome. If the Internet worm attack is generated, the traffic of transmission/reception packets to a specific port is increased exponentially and the traffic of packets for searching the port is increased. The function (b) is for generating such network traffic. That is, the function (b) transmits a predetermined type of packets to a predetermined port by a predetermined protocol until a predetermined time, with the amount of the packets being exponentially increased up to a predetermined bandwidth. Here, the predetermined bandwidth is a physically possible bandwidth.

The function (c) is for generating attack test packets similar to distributed service rejection attack packets. The distributed service rejection attack transmits normal packets only during a predetermined time period and then transmits the distributed service rejection attack packets in such a way that a transmission bandwidth is suddenly increased to a predetermined bandwidth.

The function (d) reads stored network packets by using various network monitoring instruments such as TCPDUMP and then retransmits the read network packets. The packets generated by the function (d) may be transmitted in such a way that they are combined with packets generated by the functions (a), (b) and (c) The function (d) provides a network traffic similar to an actual Internet environment.

The function (e) is a basic function necessary for performing the functions (a) through (d), and enables a user to randomly determine the type of packets to be generated.

The function (f) performs an attack by applying a technique for allowing attack packets not to be easily detected by an information security system when performing the function (a). The function (f) utilizes an IP fragmentation technique and URL obfuscation technique.

As described above, the network packet generation apparatus and method according to the present invention improves the accuracy and reliability of the information security system by generating attack test packets identical to or very similar to actual attack packets generated in the Internet, thereby performing the information security system test efficiently.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A network packet generation apparatus with an attack test packet generation function for testing a performance of an information security system, the apparatus comprising:
a system controller for setting attack test packets according to received setting data about the attack test packets and a pre-stored attack detection rule and combining the attack test packets with monitored reaction packets thereagainst;
a packet generator for generating the attack test packets according to the setting data;
a packet monitor for monitoring the attack test packets and the reaction packets received from the information security system;
a connection managing unit for connecting and managing a network; and
network interface cards respectively connected to the packet generator and the packet monitor.

2. The apparatus of claim 1, wherein the system controller comprises:
an overall management interface for generating setting data corresponding to a user's manipulation, receiving monitored packets and thereby setting overall attack packets;
an intrusion detection rule loader for storing an intrusion detection rule; and
a packet setting transmitter for transmitting attack test packets' settings generated by the overall management interface.

3. The apparatus of claim 1, wherein the packet generator comprises:
a transmission packet setting receiver for receiving the attack test packets' settings generated by the system ten controller;
a packet generator group comprising a common hacking packet generator and a service rejection attack packet generator and an Internet worm attack packet generator and a scan attack packet generator that generate respective hacking packets according to respective packets' settings and a background packet generator for generating background traffics; and
a transmission packet combiner for combining overall packets prior to transmission.

4. The apparatus of claim 3, wherein the packet generator further comprises an attack packet modifier connected between the transmission packet combiner and the packet generator group, for modifying packets generated by the packet generator group according to the attack test packets' settings received from the transmission packet setting receiver.

5. The apparatus of claim 1, wherein the packet monitor comprises:
a transmission packet setting receiver for receiving a transmission packets' settings;
a packet receiver for receiving packets and selectively transmitting the received packets to the connection managing unit; and
a received packet information transmitter for transmitting received packet information.

6. A network packet generation method with an attack test packet generation function for testing a performance of an information security system, the method comprising the steps of:
(a) setting attack test packets according to setting data inputted by a user and a pre-stored attack detection rule;
(b) generating the attack test packets according to the setting data;
(c) transmitting the attack test packets to the information security system and receiving monitored and stored reaction packets against the attack test packets; and
(d) analyzing the received reaction packets.

7. The method of claim 6, wherein the step (b) comprises the steps of:
generating attack test packets according to a common hacking technique;
generating attack test packets according to an Internet worm technique; and
generating attack test packets according to a distributed service rejection attack technique.

8. The method of claim 7, wherein the step of generating the attack test packets according to the common hacking technique comprises the steps of:
determining a format of an attack test packet according to an intrusion detection rule contained in a conventional information security system;
selecting an attack type to be used for an information security system test
setting a connection according to a corresponding protocol and network port number if the selected attack is an attack performed through a connection-based protocol; and
performing attacks by using the set connection.

9. The method of claim 7, wherein the step of generating the attack test packets according to the Internet worm technique transmits a predetermined type of packets to a predetermined port by a predetermined protocol until a predetermined time, with the amount of the packets being exponentially increased up to a predetermined bandwidth.

10. The method of claim 7, wherein the step of generating the attack test packets according to the distributed service rejection attack technique transmits normal packets only during a predetermined time period and then transmits distributed service rejection attack packets in such a way that a transmission bandwidth is suddenly increased to a predetermined bandwidth.

11. The method of claim 6, further comprising the step of reading stored network packets by using a network monitoring instrument including TCPDUMP and then retransmitting the read network packets to the information security system.

12. The method of claim 11, wherein the read network packets are retransmitted in such a way that they are combined with common hacking attack test packets, Internet worm attack test packets and distributed service rejection attack test packets.

13. The method of claim 6, wherein a technique for allowing attack packets not to be easily detected by the information security system is applied so as to prevent an easy intrusion of actual attack packets into the information security system.
